(19) United States
(12) Patent Application Publication
(10) Pub. No.: US 2026/0230791 A1
(43) Pub. Date: Aug. 6, 2026

(54) LINK DELETION FOR SEAMLESS ROAMING IN WLANS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Frisco, TX (US); Vishnu Vardhan Ratnam, Frisco, TX (US); Yue Qi, Plano, TX (US); Bilal Sadiq, Plano, TX (US)

(21) Appl. No.: 19/446,860

(22) Filed: Jan. 12, 2026

Related U.S. Application Data
(60) Provisional application No. 63/751,950, filed on Jan. 31, 2025.
(60) Provisional application No. 63/767,930, filed on Mar. 6, 2025.
(60) Provisional application No. 63/802,309, filed on May 8, 2025.
(60) Provisional application No. 63/845,923, filed on Jul. 17, 2025.
(60) Provisional application No. 63/910,255, filed on Nov. 3, 2025.

(51) Int. Cl. H04W 8/08; H04W 76/15

(52) U.S. Cl. CPC H04W 8/08; H04W 76/15

(57) ABSTRACT

Methods and apparatuses for link deletion for seamless roaming in Wireless Local Area Networks (WLANs). A method of wireless communication performed by a first access point (AP) multi-link device (MLD) of a seamless mobility domain comprises receiving, from a non-AP MLD that is associated with the first AP MLD and that has links setup with the first AP MLD, a roam request message to roam from the first AP MLD to a second AP MLD of the seamless mobility domain. The method includes transmitting data to the non-AP MLD for a duration of time after roam execution completion, and performing a link deletion procedure for deleting the links that were setup between the non-AP MLD and the first AP MLD.

### CROSS-REFERENCE TO RELATED APPLICATION(S) AND CLAIM OF PRIORITY

This application claims priority under 35 U.S.C. § 119(e) to U.S. Provisional Patent Application No. 63/751,950, filed on Jan. 31, 2025, U.S. Provisional Patent Application No. 63/767,930, filed on Mar. 6, 2025, U.S. Provisional Patent Application No. 63/802,309, filed on May 8, 2025, U.S. Provisional Patent Application No. 63/845,923, filed on Jul. 17, 2025, and U.S. Provisional Patent Application No. 63/910,255, filed on Nov. 3, 2025, each of which are hereby incorporated by reference in their entirety.

### TECHNICAL FIELD

This disclosure relates generally to wireless communication, and more specifically to link deletion for seamless roaming in Wireless Local Area Networks (WLANs).

### BACKGROUND

Wireless Local Area Network (WLAN) technology allows devices to access the internet in the 2.4 GHz, 5 GHz, 6 GHz or 60 GHz frequency bands. WLANs are based on the Institute of Electrical and Electronic Engineers (IEEE) 802.11 standards. IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax, etc.

### SUMMARY

Embodiments of the present disclosure provide methods and apparatuses for link deletion for seamless roaming in WLANs.

In one embodiment, a method of wireless communication performed by a first access point (AP) multi-link device (AP MLD) of a seamless mobility domain comprises receiving, from a non-AP MLD that is associated with the first AP MLD and that has links setup with the first AP MLD, a roam request message to roam from the first AP MLD to a second AP MLD of the seamless mobility domain. The method includes transmitting data to the non-AP MLD for a duration of time after roam execution completion, and performing a link deletion procedure for deleting the links that were setup between the non-AP MLD and the first AP MLD.

In another embodiment, a method performed by a non-AP MLD of a seamless mobility domain comprises transmitting, to a first AP MLD that is associated with the non-AP MLD and that has links setup with the non-AP MLD, a roam request message to roam from the first AP MLD to a second AP MLD of the seamless mobility domain. The method includes receiving data from the first AP MLD for a duration of time after roam execution completion, and performing a link deletion procedure for deleting the links that were setup between the non-AP MLD and the first AP MLD.

In yet another embodiment, an electronic device comprises at least one processor including processing circuitry, and memory storing instructions, where the instructions, when executed by the at least one processor individually or collectively, cause the electronic device to: receive, from a non-AP MLD that is associated with the first AP MLD and that has links setup with the first AP MLD, a roam request message to roam from the first AP MLD to a second AP MLD of the seamless mobility domain; transmit data to the non-AP MLD for a duration of time after roam execution completion; and perform a link deletion procedure for deleting the links that were setup between the non-AP MLD and the first AP MLD.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2A illustrates an example access point (AP) according to embodiments of the present disclosure;

FIG. 2B illustrates an example station (STA) according to embodiments of the present disclosure;

FIG. 3 illustrates an example of link reconfiguration for adding and deleting links according to embodiments of the present disclosure;

FIG. 4 illustrates an example procedure for timeout based link deletion according to embodiments of the present disclosure;

FIG. 5 illustrates an example procedure for timeout value advertisement by the AP MLD according to embodiments of the present disclosure;

FIG. 6 illustrates an example procedure for timeout value in a response message by the AP MLD according to embodiments of the present disclosure;

FIG. 7 illustrates an example control field format for the reconfiguration multi-link element according to embodiments of the present disclosure;

FIG. 8 illustrates an example STA information field format for the reconfiguration multi-link element according to embodiments of the present disclosure;

FIG. 9 illustrates an example non-AP side procedure for link deletion according to embodiments of the present disclosure;

FIG. 10 illustrates an example procedure for transmitting a link deletion message to the new AP according to embodiments of the present disclosure;

FIG. 11 illustrates an example procedure for transmitting a link deletion message to the old AP according to embodiments of the present disclosure;

FIG. 12 illustrates an example AP side procedure for link deletion according to embodiments of the present disclosure;

FIG. 13 illustrates an example procedure for transmitting a link deletion message through the new AP MLD according to embodiments of the present disclosure;

FIG. 14 illustrates an example procedure for transmitting a link deletion message to through the old AP MLD according to embodiments of the present disclosure;

FIG. 15 illustrates an example procedure for non-AP side inference of completion of buffer on the AP MLD side according to embodiments of the present disclosure; and

FIG. 16 illustrates an example method performed by a first AP MLD in a wireless communication system according to embodiments of the present disclosure.

### DETAILED DESCRIPTION

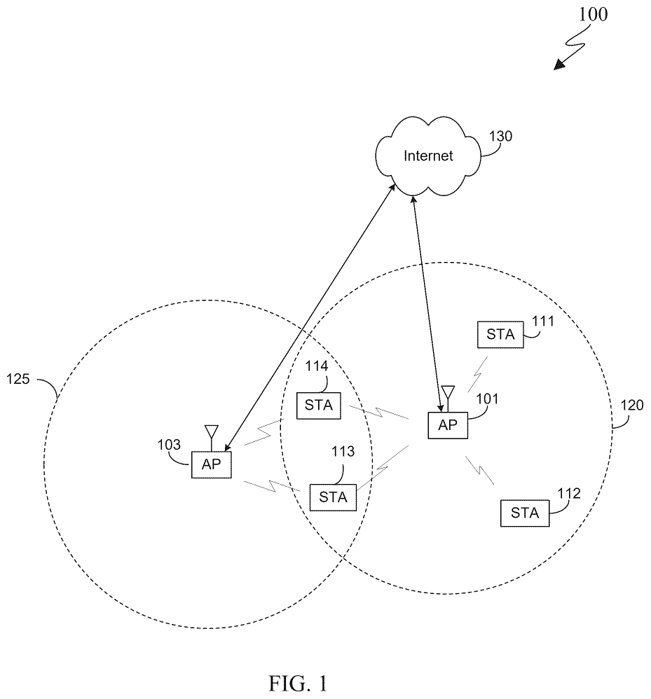

FIGS. 1 through 16, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Existing WLAN standards support multiple bands of operation, where an access point (AP) and a non-AP device may communicate with each other, called links. Thus, both the AP and non-AP device may be capable of communicating on different bands/links, which is referred to as multi-link operation (MLO). Devices capable of such MLO are referred to as multi-link devices (MLDs).

The following documents and standards descriptions are hereby incorporated by reference into the present disclosure as if fully set forth herein: [1] IEEE P802.11be/D7.0, 2024; [2] IEEE Std 802.11-2020.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating link deletion for seamless roaming. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

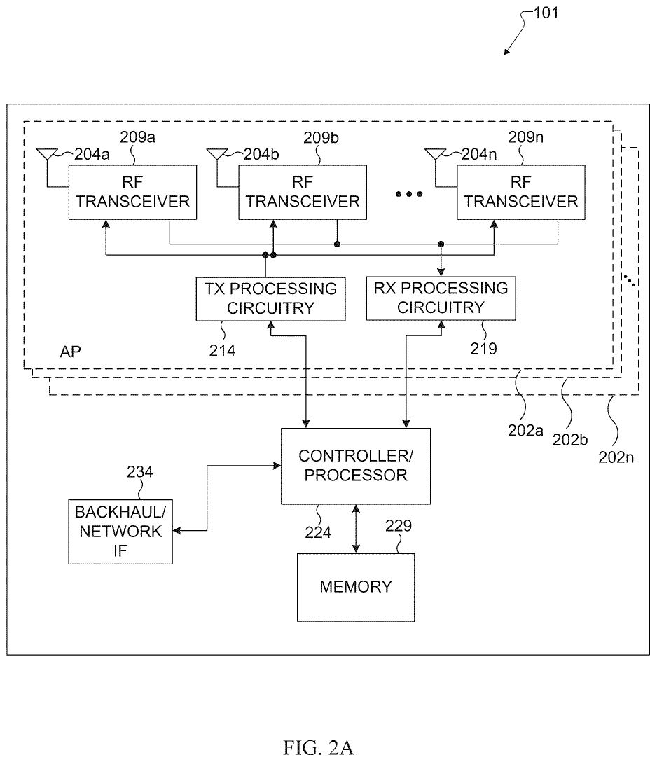

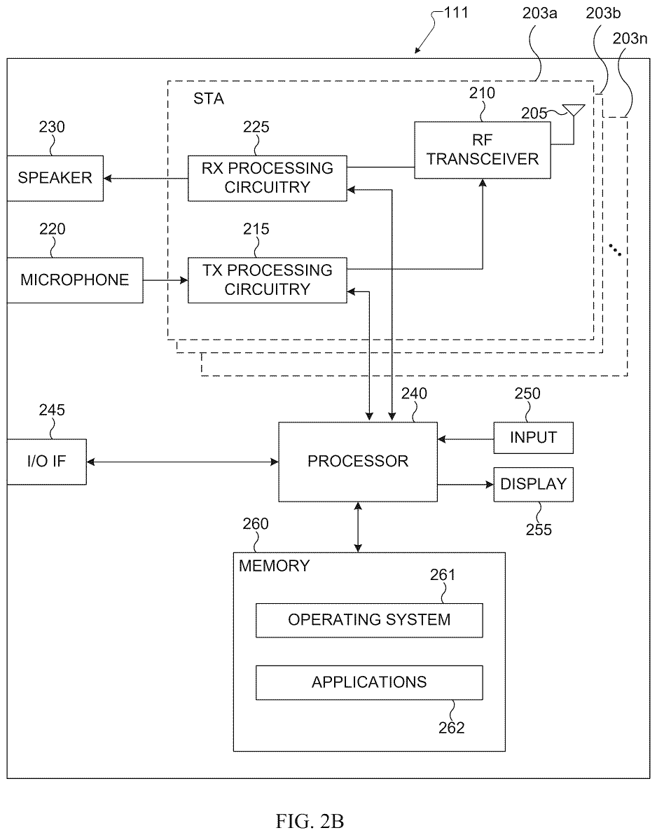

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHz, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including DL data handling in seamless roaming in WLANs. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating link deletion for seamless roaming. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a processor 240, an input/output (I/O) interface (IF) 245, an input 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The processor 240 can include one or more processors and execute the basic OS program 261 stored in the memory 260 in order to control the overall operation of the non-AP MLD 111. In one such operation, the processor 240 controls the reception of forward channel signals and the transmission of reverse channel signals by the RF transceiver 210, the RX processing circuitry 225, and the TX processing circuitry 215 in accordance with well-known principles. The processor 240 can also include processing circuitry configured to facilitate link deletion for seamless roaming. In some embodiments, the processor 240 includes at least one microprocessor or microcontroller.

The processor 240 is also capable of executing other processes and programs resident in the memory 260, such as operations for facilitating link deletion for seamless roaming. The processor 240 can move data into or out of the memory 260 as required by an executing process. In some embodiments, the processor 240 is configured to execute a plurality of applications 262, such as applications for facilitating link deletion for seamless roaming. The processor 240 can operate the plurality of applications 262 based on the OS program 261 or in response to a signal received from an AP. The processor 240 is also coupled to the I/O interface 245, which provides non-AP MLD 111 with the ability to connect to other devices such as laptop computers and handheld computers. The I/O interface 245 is the communication path between these accessories and the processor 240.

The processor 240 is also coupled to the input 250 and the display 255. The operator of the non-AP MLD 111 can use the input 250 to enter data into the non-AP MLD 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

A goal of seamless roaming is to provide mechanisms for a non-AP MLD to transition from the current AP MLD to the target AP MLD such that the time during which the connection is lost is minimal. The seamless roaming procedure can enable a non-AP MLD to remain in state 4 while transitioning from the current AP MLD to the target AP MLD.

The roaming procedure can comprise multiple stages. Two of the stages are a preparation stage and roam execution stage. During the preparation stage, the non-AP MLD can setup links with the target AP MLD and perform context transfer. Following this stage, the non-AP MLD can perform a roam execution procedure by sending a request frame to transition from current AP MLD to target AP MLD. The current AP MLD can process the request frame and send a response frame to the non-AP MLD after the transfer of context is complete.

These procedures should be designed to enable the non-AP MLD to seamlessly roam from the current to the target AP MLD.

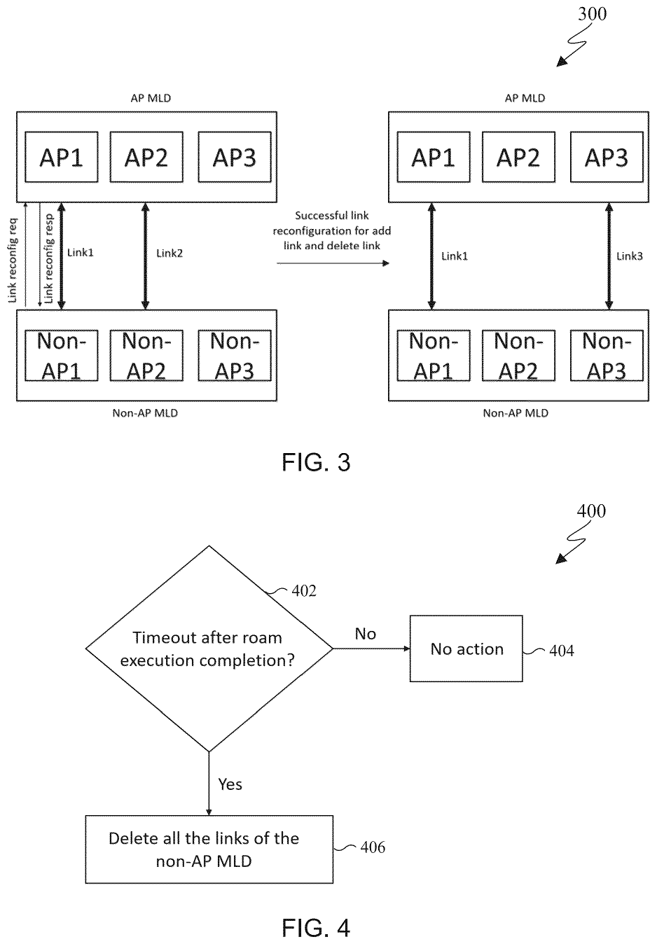

FIG. 3 illustrates an example of link reconfiguration for adding and deleting links 300 according to embodiments of the present disclosure. The embodiment of the example of link reconfiguration for adding and deleting links 300 shown in FIG. 3 is for illustration only. Other embodiments of the example of link reconfiguration for adding and deleting links could be used without departing from the scope of this disclosure.

The baseline specification provides a link reconfiguration procedure to enable the non-AP MLD to add or delete one or more of its links with its current AP MLD. The add or delete operation can be performed by the non-AP MLD by transmitting a link reconfiguration request frame to the current AP MLD as depicted in FIG. 3.

Embodiments of the present disclosure recognize scenarios where a non-access point (non-AP) multi-link device (non-AP MLD) is connected to a seamless mobility domain (SMD). The SMD can include multiple access point (AP) multi-link devices (AP MLDs) where it can transition between the AP MLDs. There can be a seamless mobility domain management entity (SMD-ME) for the SMD. The SMD-ME can allow functionalities such as SMD-level authentication and association, IEEE 802.1X authenticator functions and robust security network association (RSNA) key management functions for non-AP MLDs across all AP MLDs within the SMD. The SMD can support two data path models between the non-AP MLD and the distribution system (DS). The first can be one that has one medium access control (MAC) service access point (SAP) for the SMD and the second can be one that has a separate MAC SAP per AP MLD of the SMD. The SMD can only have one of these data path models used. The SMD and the 802.1X Authenticator component in the corresponding SMD-ME are uniquely identified by an SMD identifier.

When the non-AP MLD associates with an AP MLD 1 of the SMD, the non-AP MLD can setup links with the AP MLD 1, for example, by the use of a link reconfiguration procedure. At a later point in time, the non-AP MLD may want to transition to another AP MLD in the same SMD (for example AP MLD 2). When a non-AP MLD roams from AP MLD1 to AP MLD2, a procedure and behavior is needed for handling the links with the AP MLD1. For the remainder of this disclosure, AP MLD1 can be referred to as the old AP MLD and AP MLD2 can be referred to as the new AP MLD. AP MLD 1 can also be referred to as the current AP MLD and AP MLD 2 can be referred to as the target AP MLD.

Embodiments of the present disclosure provide a procedure that can be followed during a phase that occurs after the completion of the transition/ST execution procedure with the old AP MLD. During this period, the old AP MLD can continue to transmit data to the non-AP MLD. At the end of this phase (marked by a timeout value), the non-AP MLD and the old AP MLD can delete the links between them. The procedure to indicate the timeout value (timeout can also be called as nominal maximum DL draining period duration) and the corresponding behavior are described in section 1 herein. However, prior to the completion of this period, the non-AP MLD can also signal to the old AP MLD a termination of DL draining period. Procedures and behavior for this part are described in section 2 herein. In the same manner, the old AP MLD can also signal to the non-AP MLD about the termination of the DL draining period. The procedures and behavior for this part are described in section 3 herein.

In this disclosure, a number of solutions are presented for handling link deletion at the current AP MLD, including (1) timeout based deletion; (2) non-AP MLD side indication based deletion and signaling; and (3) AP MLD side indication based deletion and signaling

### 1. Timeout Based Deletion

FIG. 4 illustrates an example procedure 400 for timeout based link deletion according to embodiments of the present disclosure. The embodiment of the example procedure 400 for timeout based link deletion shown in FIG. 4 is for illustration only. Other embodiments of the example procedure for timeout based link deletion could be used without departing from the scope of this disclosure.

As shown in FIG. 4, the procedure 400 begins at step 402, where a determination is made whether there is a timeout after roam execution completion. If there is no timeout after roam execution completion, then at step 404, no action is taken. If there is timeout after roam execution completion, then at step 406, all the links of the non-AP MLD can be deleted.

According to one embodiment, there can be a timeout value after which the links at the old AP MLD can be deleted. This timeout can be an amount of time that is needed to drain the downlink buffer of the old AP MLD. If the timeout value is zero, then the links can be deleted right after the completion of the execution procedure

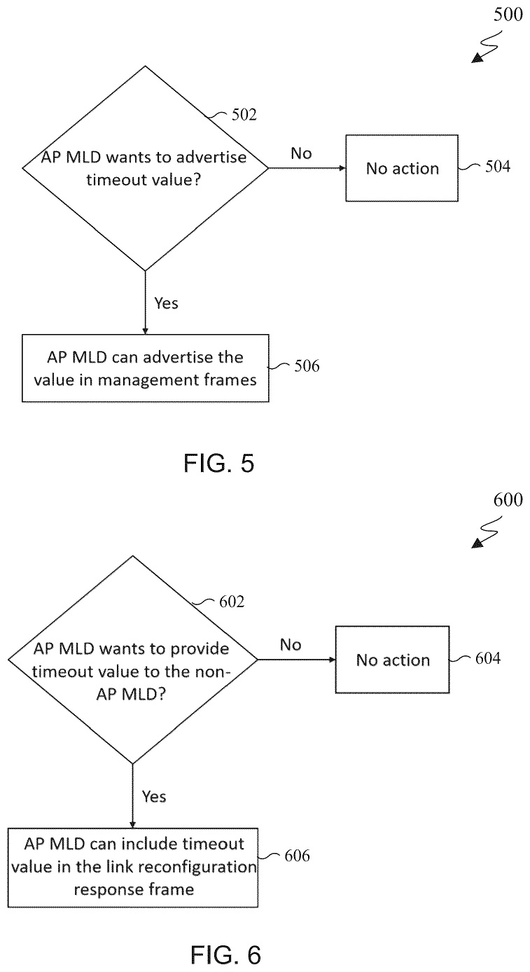

FIG. 5 illustrates an example procedure 500 for timeout value advertisement by the AP MLD according to embodiments of the present disclosure. The embodiment of the example procedure 500 for timeout value advertisement by the AP MLD shown in FIG. 5 is for illustration only. Other embodiments of the example procedure for timeout value advertisement by the AP MLD could be used without departing from the scope of this disclosure.

As shown in FIG. 5, the procedure 500 begins at step 502, where a determination is made whether the AP wants to advertise a timeout value. If the AP does not want to advertise a timeout value, then at step 504, no action is taken. If the AP wants to advertise a timeout value, then at step 506, the AP MLD can advertise the timeout value in management frames.

FIG. 6 illustrates an example procedure 600 for timeout value in a response message by the AP MLD according to embodiments of the present disclosure. The embodiment of the example procedure 600 for timeout value in a response message by the AP MLD shown in FIG. 6 is for illustration only. Other embodiments of the example procedure for timeout value in a response message by the AP MLD could be used without departing from the scope of this disclosure.

As shown in FIG. 6, the procedure 600 begins at step 602, where a determination is made whether the AP wants to provide a timeout value to the non-AP MLD. If the AP does not want to provide a timeout value to the non-AP MLD, then at step 604, no action is taken. If the AP wants to provide a timeout value to the non-AP MLD, then at step 606, the AP MLD can include the timeout value in the link reconfiguration response frame.

The link reconfiguration response frame that can carry the timeout value can have a format as shown in Table 1.

TABLE 1
Format for the link reconfiguration response frame

| Order | Meaning |
|---|---|
| 1 | Category |
| 2 | Protected EHT/UHR Action |
| 3 | Dialog Token |
| 4 | Timeout |
| 5 | Count |
| 6 | Reconfiguration Status List |
| 7 | Group Key Data (optional) |
| 8 | OCI element (optional) |
| 9 | Basic Multi-link element (optional) |

The order can be different than that shown in this example. There can also be additional information items present.

When a non-AP MLD receives a timeout value from an AP MLD in the link reconfiguration response frame used as a roam response message, then the non-AP MLD can understand that its links with that AP MLD can be deleted after a timeout period of time.

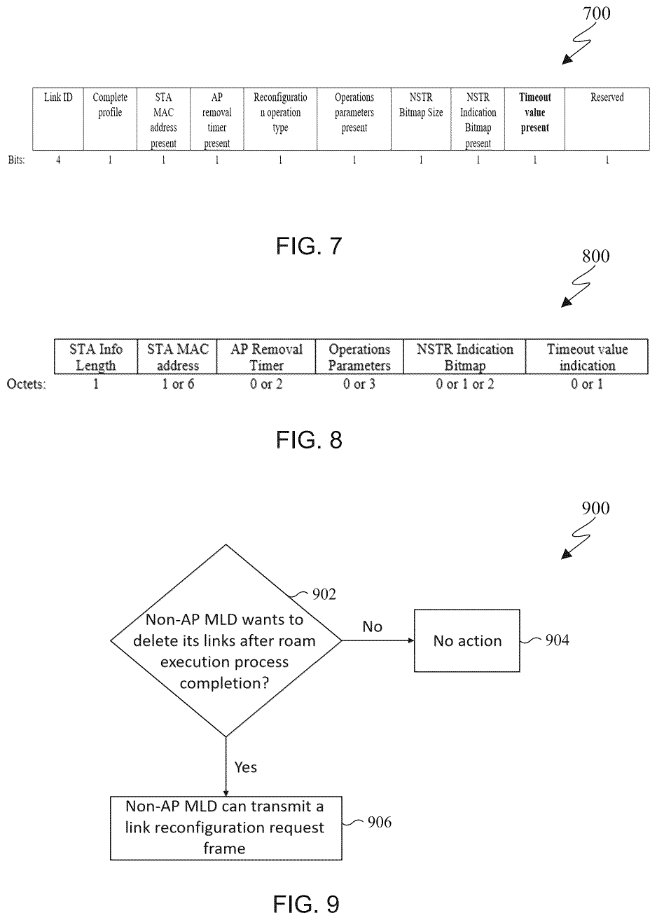

FIG. 7 illustrates an example control field format for the reconfiguration multi-link element 700 according to embodiments of the present disclosure. The embodiment of the example control field format for the reconfiguration multi-link element 700 shown in FIG. 7 is for illustration only. Other embodiments of the example control field format for the reconfiguration multi-link element could be used without departing from the scope of this disclosure.

As shown in FIG. 7, according to another embodiment, the timeout value can also be carried in the reconfiguration multi-link element. The timeout value can be set to 1 if the timeout is present in the reconfiguration multi-link element and to 0 if it is absent.

FIG. 8 illustrates an example STA information field format for the reconfiguration multi-link element 800 according to embodiments of the present disclosure. The embodiment of the example STA information field format for the reconfiguration multi-link element 800 shown in FIG. 8 is for illustration only. Other embodiments of the example STA information field format for the reconfiguration multi-link element could be used without departing from the scope of this disclosure.

As shown in FIG. 8, if the timeout value present bit is set to 1, the STA information field format can carry a timeout value and the STA information length value can be set to reflect the presence of the timeout value.

According to another embodiment, the timeout value can be carried in a newly defined element.

According to another embodiment, the timeout value can also be advertised by the AP MLD in a SMD information element and can be applicable for all the AP MLDs in the SMD.

### 2. Non-AP MLD Side Indication Based Deletion

According to one embodiment, the non-AP MLD can provide an indication to the old AP MLD to delete its links. The non-AP MLD can transmit a message to the old AP MLD to inform the old AP MLD about the need to delete the links.

The message can contain at least one or more of the information items as shown in Table 2.

TABLE 2
Information items that can be present in the link deletion message

| Information items | Description |
|---|---|
| Links to delete | One or more information items that can indicate the links that can be |
| | deleted. For example, the link ID, basic multi-link element that can |
| | show the new set of links and thus indicate the AP MLD to delete the |
| | old set of links. |
| Deadline | One or more information items that can indicate a time by which the |
| | links can be deleted. |
| AP MLD identifier | One or more information items that can indicate the identifier of the |
| | AP MLD. E.g., AP MLD MAC address, AP MLD ID, etc. |
| Early termination | One or more information items that can indicate that the DL retrieval |
| of DL (downlink) | is terminated/completed. For example, a bit that can take a |
| data | predetermined value to make the indication and to another value to |
| | indicate otherwise, a field (e.g., a type field) that can carry a |
| | predetermined value (e.g., 3) to make the indication. The completion |
| | of the downlink retrieval can be indicated for all the traffic types |
| | together or can be indicated per traffic category. For example, for |
| | different TIDs, ACs, etc. |
| Traffic type for | One or more information items indicating a list of traffic types for |
| which early | which early termination of DL data applies. For example, there can be |
| termination of DL | a TID bitmap. A value of 1 in the bit position i of the TID bitmap can |
| data applies | indicate to the recipient that the indication for an early termination of |
| | DL data applies to the TID i. |
| | Another example can be to indicate individual TIDs coupled with a |
| | field that carries a value to indicate if an early termination of DL data |
| | applies to that TID or not. |
| | Another example is an AC bitmap. |

FIG. 9 illustrates an example non-AP side procedure 900 for link deletion according to embodiments of the present disclosure. The embodiment of the example non-AP side procedure 900 for link deletion shown in FIG. 9 is for illustration only. Other embodiments of the example non-AP side procedure for link deletion could be used without departing from the scope of this disclosure.

When a non-AP MLD has completed the roam execution procedure with the old AP MLD, the old AP MLD can delete all the links with the non-AP MLD via the link deletion message.

As shown in FIG. 9, the procedure 900 begins at step 902, where a determination is made whether the non-AP MLD wants to delete its links after roam execution process completion. If the non-AP MLD does not want to delete its links after roam execution process completion, then at step 904, no action is taken. If the AP wants to delete its links after roam execution process completion, then at step 906, the AP MLD can transmit a link reconfiguration request frame.

According to one embodiment, the link deletion message can be a link reconfiguration request frame transmitted to the old AP MLD. The link reconfiguration request frame can indicate in the reconfiguration operation type a value corresponding to delete link operation. The complete per-STA profile can be absent in such a message (e.g., by setting the complete profile subfield in the STA control field of the reconfiguration multi-link element to 0).

According to another embodiment, the link deletion message can be a link reconfiguration notify frame. The link reconfiguration notify frame can carry a reconfiguration ML element that can indicate a link deletion operation for all the links established with the AP MLD if the non-AP MLD has completed the roam execution procedure with the AP MLD. According to another embodiment, the link reconfiguration notify frame can be a UHR frame with a type field that can indicate an early termination of DL transmissions or completion of DL retrieval.

According to another embodiment, the message can be in the form of an A-control subfield which can contain a bit that can indicate the link deletion or termination. The bit can take a value of 1 to make an indication of link deletion or early termination and to another value to indicate otherwise. The indication can be carried in a QoS Null, QoS Data or Management frame.

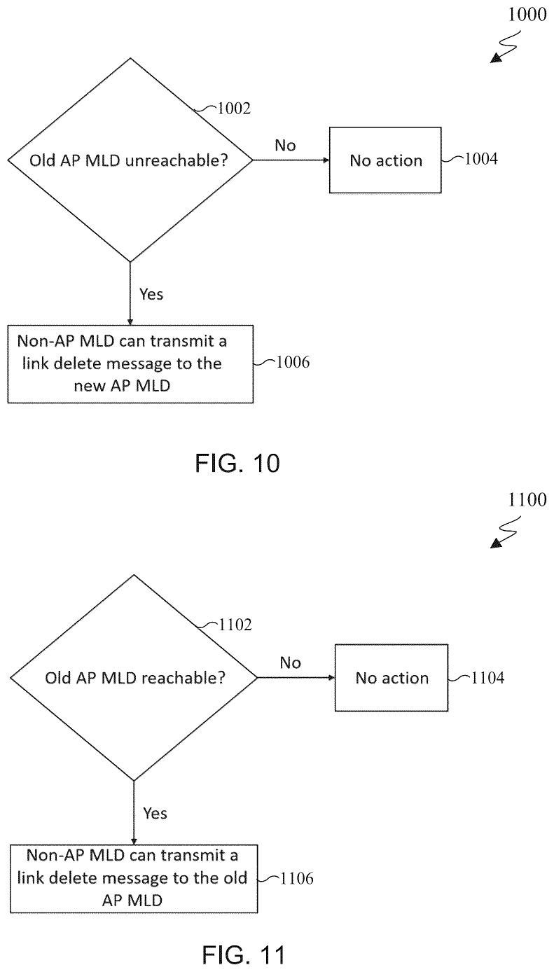

FIG. 10 illustrates an example procedure 1000 for transmitting a link deletion message to the new AP according to embodiments of the present disclosure. The embodiment of the example procedure 1000 for transmitting a link deletion message to the new AP shown in FIG. 10 is for illustration only. Other embodiments of the example procedure for transmitting a link deletion message to the new AP could be used without departing from the scope of this disclosure.

According to one embodiment, the link deletion message can be transmitted to the new AP MLD. For example, if the DLDrainTime ends without an early termination then the non-AP MLD can make an indication to the new AP MLD.

According to another embodiment, the indication can also be made in the form of a status code instead of a bit based indication.

As shown in FIG. 10, the procedure 1000 begins at step 1002, where a determination is made whether the old AP MLD is unreachable. If the old AP MLD is not unreachable, then at step 1004, no action is taken. If the old AP MLD is unreachable, then at step 1006, the non-AP MLD can transmit a link delete message to the new AP MLD.

According to one embodiment, the link deletion message can be transmitted to the old AP MLD.

FIG. 11 illustrates an example procedure 1100 for transmitting a link deletion message to the old AP according to embodiments of the present disclosure. The embodiment of the example procedure 1100 for transmitting a link deletion message to the old AP shown in FIG. 11 is for illustration only. Other embodiments of the example procedure for transmitting a link deletion message to the old AP could be used without departing from the scope of this disclosure.

As shown in FIG. 11, the procedure 1100 begins at step 1102, where a determination is made whether the old AP MLD is unreachable. If the old AP MLD is not unreachable, then at step 1104, no action is taken. If the old AP MLD is unreachable, then at step 1106, the non-AP MLD can transmit a link delete message to the old AP MLD.

According to one embodiment, the AP MLD can accept a link reconfiguration request frame that requests to delete all the links setup with that AP MLD if the non-AP MLD has completed the roam execution stage with the AP MLD, i.e., the non-AP MLD has already roamed to another AP MLD.

### 3. AP MLD Side Indication Based Deletion

According to one embodiment, the AP MLD can also provide a notification of link delete to the non-AP MLD. For example, when the AP MLD has exhausted its downlink data that was buffered for the non-AP MLD. Instead of a notification of link delete, the AP MLD can also provide a notification that the DL data has been exhausted or that DL data transmission can be terminated. The notification can be solicited by the non-AP MLD or can be unsolicited. The notification can comprise at least one or more of the information items as shown in Table 3.

TABLE 3
AP side indication information items

| Information item | Description |
|---|---|
| No DL data | One or more information items that can indicate that there is no more |
| indication | pending DL data or that the AP MLD can no longer transmit any DL data |
| | to the non-AP MLD. For example, a bit that can take a predetermined |
| | value (e.g., 1) to make the indication and to another predetermined value |
| | (e.g., 0) to indicate otherwise. |
| Early | One or more information items that can indicate that the DL retrieval is |
| termination of | terminated/completed. For example, a bit that can take a predetermined |
| DL (downlink) | value to make the indication and to another value to indicate otherwise, a |
| data | field (e.g., a type field) that can carry a predetermined value (e.g., 3) to |
| | make the indication. The completion of the downlink retrieval can be |
| | indicated for all the traffic types together or can be indicated per traffic |
| | category. E.g., for different TIDs, ACs, etc. |
| Traffic type for | One or more information items indicating a list of traffic types for which |
| which early | early termination of DL data applies. For example, there can be a TID |
| termination of | bitmap. A value of 1 in the bit position i of the TID bitmap can indicate to |
| DL data applies | the recipient that the indication for an early termination of DL data applies |
| | to the TID i. |
| | Another example can be to indicate individual TIDs coupled with a field |
| | that carries a value to indicate if an early termination of DL data applies |
| | to that TID or not. |
| | Another example is an AC bitmap. |

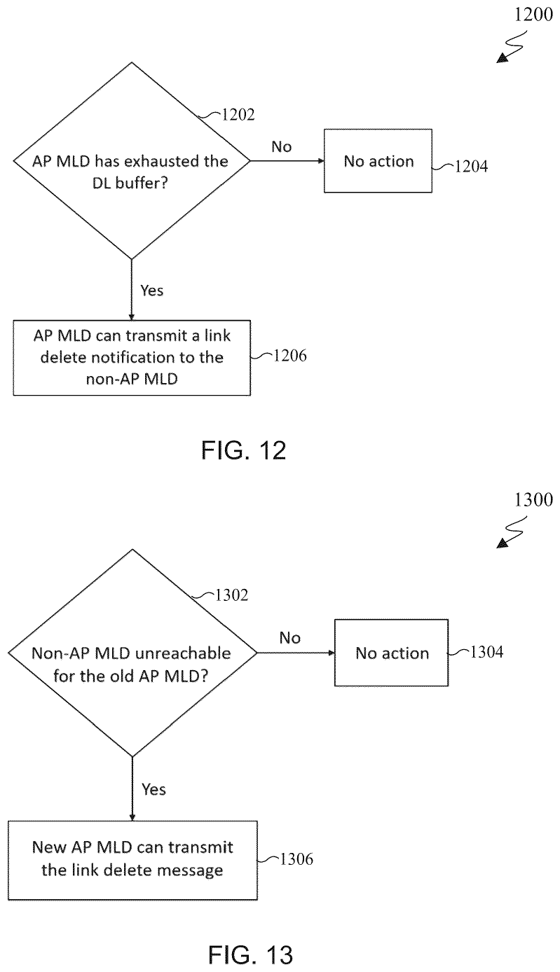

FIG. 12 illustrates an example AP side procedure 1200 for link deletion according to embodiments of the present disclosure. The embodiment of the example AP side procedure 1200 for link deletion shown in FIG. 12 is for illustration only. Other embodiments of the example AP side procedure for link deletion could be used without departing from the scope of this disclosure.

As shown in FIG. 12, the procedure 1200 begins at step 1202, where a determination is made whether the AP MLD has exhausted the downlink (DL) buffer. If the AP MLD has not exhausted the DL, then at step 1204, no action is taken. If the AP MLD AP MLD has exhausted the DL buffer, then at step 1206, the AP MLD can transmit a link delete notification to the non-AP MLD.

The AP MLD can transmit a link reconfiguration notify frame to the non-AP MLD. The link reconfiguration notify frame can carry a reconfiguration ML element that can indicate a link deletion operation for all the links established with the AP MLD if the non-AP MLD has completed the roam execution procedure with the AP MLD. According to another embodiment, the link reconfiguration notify frame can be a UHR frame with a type field that can indicate an early termination of DL transmissions or completion of DL retrieval.

According to another embodiment, the AP MLD can transmit a link reconfiguration request/response frame to the non-AP MLD. The link reconfiguration request/response frame can carry an indication to indicate an early termination of DL transmissions or completion of DL retrieval.

FIG. 13 illustrates an example procedure 1300 for transmitting a link deletion message through the new AP MLD according to embodiments of the present disclosure. The embodiment of the example procedure 1300 for transmitting a link deletion message through the new AP MLD shown in FIG. 13 is for illustration only. Other embodiments of the example procedure for transmitting a link deletion message through the new AP MLD could be used without departing from the scope of this disclosure.

The link delete operation can be performed by the old AP MLD by having the new AP MLD transmit the link delete to the non-AP MLD. For example, if the non-AP MLD is out of reach of the old AP MLD.

As shown in FIG. 13, the procedure 1300 begins at step 1302, where a determination is made whether the non-AP MLD is unreachable for the old AP MLD. If the non-AP MLD is not unreachable for the old AP MLD, then at step 1304, no action is taken. If the non-AP MLD is unreachable for the old AP MLD, then at step 1306, the new AP MLD can transmit the link delete message.

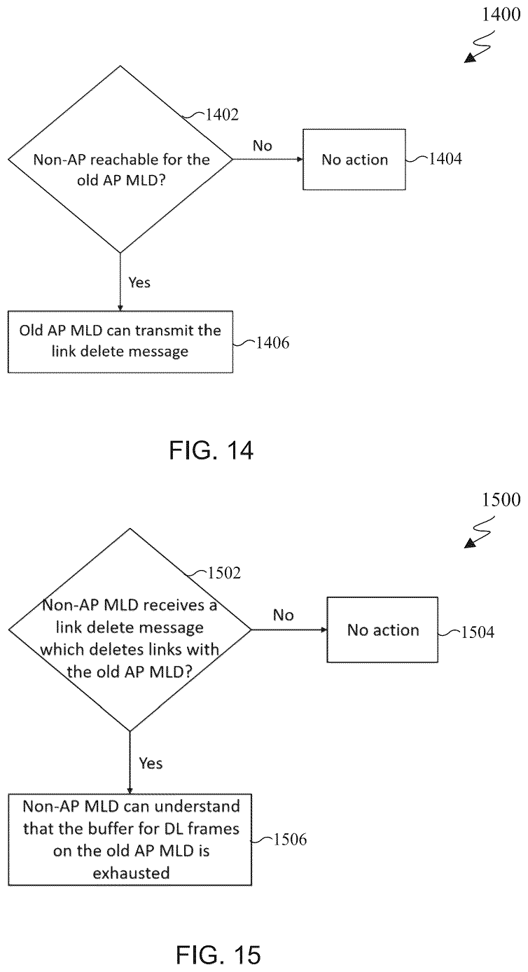

FIG. 14 illustrates an example procedure 1400 for transmitting a link deletion message through the old AP MLD according to embodiments of the present disclosure. The embodiment of the example procedure 1400 for transmitting a link deletion message through the old AP MLD shown in FIG. 14 is for illustration only. Other embodiments of the example procedure for transmitting a link deletion message through the old AP MLD could be used without departing from the scope of this disclosure.

The link delete operation can be performed by the old AP MLD by transmitting the link delete message to the non-AP MLD. For example, if the non-AP MLD is within the reach of the old AP MLD.

As shown in FIG. 14, the procedure 1400 begins at step 1402, where a determination is made whether the non-AP MLD is reachable for the old AP MLD. If the non-AP MLD is not reachable for the old AP MLD, then at step 1404, no action is taken. If the non-AP MLD is reachable for the old AP MLD, then at step 1406, the old AP MLD can transmit the link delete message.

FIG. 15 illustrates an example procedure 1500 for non-AP side inference of completion of buffer on the AP MLD side according to embodiments of the present disclosure. The embodiment of the example procedure 1500 for non-AP side inference of completion of buffer on the AP MLD side shown in FIG. 15 is for illustration only. Other embodiments of the example procedure for non-AP side inference of completion of buffer on the AP MLD side could be used without departing from the scope of this disclosure.

As shown in FIG. 15, the procedure 1500 begins at step 1502, where a determination is made whether the non-AP MLD receives a link delete message which deletes links with the old AP MLD. If the non-AP MLD does not receive a link delete message which deletes links with the old AP MLD, then at step 1504, no action is taken. If the non-AP MLD does receive a link delete message which deletes links with the old AP MLD, then at step 1506, the non-AP MLD can understand that the buffer for downlink frames on the old AP MLD is exhausted.

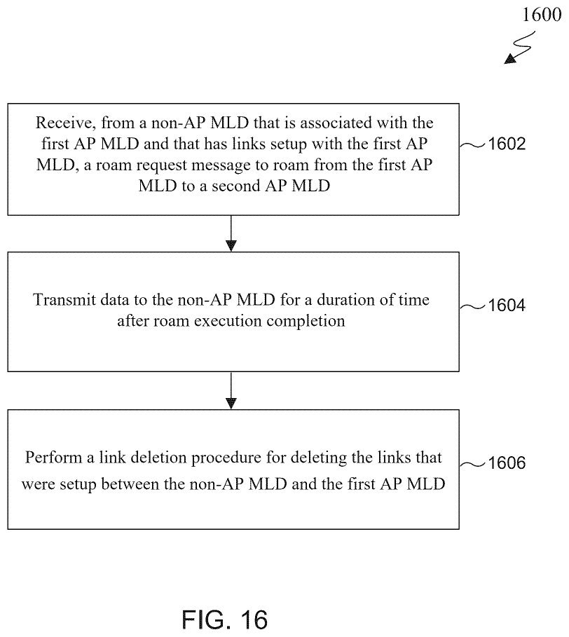

FIG. 16 illustrates an example method 1600 performed by a first AP MLD STA in a wireless communication system according to embodiments of the present disclosure. The method 1600 of FIG. 16 can be performed by any of the STAs 111-114 of FIG. 1, such as the STA 111 of FIG. 2B, and a corresponding method can be performed by any of the APs 101-103 of FIG. 1, such as AP 101 of FIG. 2A. The method 1600 is for illustration only and other embodiments can be used without departing from the scope of the present disclosure.

As illustrated in FIG. 16, the method 1600 begins at step 1602, where the first AP MLD receives, from a non-AP MLD that is associated with the first AP MLD and that has links setup with the first AP MLD, a roam request message to roam from the first AP MLD to a second AP MLD. At step 1604, the first AP MLD transmits data to the non-AP MLD for a duration of time after roam execution completion. At step 1606, the first AP MLD performs a link deletion procedure for deleting the links that were setup between the non-AP MLD and the first AP MLD.

In some embodiments, the link deletion procedure comprises a timeout based deletion procedure that includes a timeout duration, and the first AP MLD transmits the timeout duration to the non-AP MLD via a response message to the roam request message, and deletes the links that were setup between the non-AP MLD and the first AP MLD after expiration of the timeout duration.

In some embodiments, the response message comprises a link reconfiguration response frame that carries the timeout duration.

In some embodiments, the link reconfiguration response frame includes information associated with at least one of a category, a protected ultra-high reliability/extremely high throughput (UHR/EHT) action, a dialog token, a timeout, a count, a reconfiguration status list, group key data, an operation channel information (OCI) element target, and a multi-link element.

In some embodiments, the duration of time comprises a downlink draining period which includes an amount of time needed to drain a downlink buffer of the first AP MLD.

In some embodiments, the first AP MLD receives, from the non-AP MLD, a link reconfiguration notify frame that includes an indication of early termination of the downlink draining period, deletes the links that were setup between the non-AP MLD and the first AP MLD based on the indication of early termination of the downlink draining period.

In some embodiments, the first AP MLD transmits an indication to the non-AP MLD to delete the links that were setup between the non-AP MLD and the first AP MLD.

The flowcharts herein illustrate example methods or processes that can be implemented in accordance with the principles of the present disclosure and various changes could be made to the methods or processes illustrated in the flowcharts. For example, while shown as a series of steps, various steps could overlap, occur in parallel, occur in a different order, or occur multiple times. In another example, steps may be omitted or replaced by other steps.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method performed by a first access point (AP) multi-link device (MLD) of a seamless mobility domain, the method comprising:
receiving, from a non-AP MLD that is associated with the first AP MLD and that has links setup with the first AP MLD, a roam request message to roam from the first AP MLD to a second AP MLD of the seamless mobility domain;
transmitting data to the non-AP MLD for a duration of time after roam execution completion; and
performing a link deletion procedure for deleting the links that were setup between the non-AP MLD and the first AP MLD.

2. The method of claim 1, wherein the link deletion procedure comprises a timeout based deletion procedure that includes a timeout duration, the method further comprising:
transmitting the timeout duration to the non-AP MLD via a response message to the roam request message; and
deleting the links that were setup between the non-AP MLD and the first AP MLD after expiration of the timeout duration.

3. The method of claim 2, wherein the response message comprises a link reconfiguration response frame that carries the timeout duration.

4. The method of claim 3, wherein the link reconfiguration response frame includes information associated with at least one of a category, a protected ultra-high reliability/extremely high throughput (UHR/EHT) action, a dialog token, a timeout, a count, a reconfiguration status list, group key data, an operation channel information (OCI) element target, and a multi-link element.

5. The method of claim 1, wherein the duration of time comprises a downlink draining period which includes an amount of time needed to drain a downlink buffer of the first AP MLD.

6. The method of claim 5, wherein the link deletion procedure comprises:
receiving, from the non-AP MLD, a link reconfiguration notify frame that includes an indication of early termination of the downlink draining period; and
deleting the links that were setup between the non-AP MLD and the first AP MLD based on the indication of early termination of the downlink draining period.

7. The method of claim 1, wherein the link deletion procedure comprises transmitting an indication to the non-AP MLD to delete the links that were setup between the non-AP MLD and the first AP MLD.

8. A method performed by a non-access point (AP) multi-link device (MLD) of a seamless mobility domain, the method comprising:
transmitting, to a first AP MLD that is associated with the non-AP MLD and that has links setup with the non-AP MLD, a roam request message to roam from the first AP MLD to a second AP MLD of the seamless mobility domain;
receiving data from the first AP MLD for a duration of time after roam execution completion; and
performing a link deletion procedure for deleting the links that were setup between the non-AP MLD and the first AP MLD.

9. The method of claim 8, wherein the link deletion procedure comprises a timeout based deletion procedure that includes a timeout duration, the method further comprising:
receiving the timeout duration from the first AP MLD via a response message to the roam request message; and
deleting the links that were setup between the non-AP MLD and the first AP MLD after expiration of the timeout duration.

10. The method of claim 9, wherein the response message comprises a link reconfiguration response frame that carries the timeout duration.

11. The method of claim 10, wherein the link reconfiguration response frame includes information associated with at least one of a category, a protected ultra-high reliability/extremely high throughput (UHR/EHT) action, a dialog token, a timeout, a count, a reconfiguration status list, group key data, an operation channel information (OCI) element target, and a multi-link element.

12. The method of claim 8, wherein the duration of time comprises a downlink draining period which includes an amount of time needed to drain a downlink buffer of the first AP MLD.

13. The method of claim 12, wherein the link deletion procedure comprises:
transmitting, to the first AP MLD, a link reconfiguration notify frame that includes an indication of early termination of the downlink draining period; and
deleting the links that were setup between the non-AP MLD and the first AP MLD based on the indication of early termination of the downlink draining period.

14. The method of claim 8, wherein the link deletion procedure comprises receiving an indication from the first AP MLD to delete the links that were setup between the non-AP MLD and the first AP MLD.

15. An electronic device comprising:
at least one processor including processing circuitry; and
memory storing instructions, wherein the instructions, when executed by the at least one processor individually or collectively, cause the electronic device to:
receive, from a non-access point (AP) multi-link device (MLD) that is associated with a first AP MLD and that has links setup with the first AP MLD, a roam request message to roam from the first AP MLD to a second AP MLD of a seamless mobility domain;
transmit data to the non-AP MLD for a duration of time after roam execution completion; and
perform a link deletion procedure for deleting the links that were setup between the non-AP MLD and the first AP MLD.

16. The electronic device of claim 15, wherein:
the link deletion procedure comprises a timeout based deletion procedure that includes a timeout duration, and
the instructions, when executed by the at least one processor individually or collectively, cause the electronic device to:
transmit the timeout duration to the non-AP MLD via a response message to the roam request message; and
delete the links that were setup between the non-AP MLD and the first AP MLD after expiration of the timeout duration.

17. The electronic device of claim 16, wherein the response message comprises a link reconfiguration response frame that carries the timeout duration.

18. The electronic device of claim 17, wherein the link reconfiguration response frame includes information associated with at least one of a category, a protected ultra-high reliability/extremely high throughput (UHR/EHT) action, a dialog token, a timeout, a count, a reconfiguration status list, group key data, an operation channel information (OCI) element target, and a multi-link element.

19. The electronic device of claim 15, wherein the duration of time comprises a downlink draining period which includes an amount of time needed to drain a downlink buffer of the first AP MLD.

20. The electronic device of claim 19, wherein the instructions, when executed by the at least one processor individually or collectively, cause the electronic device to:
receive, from the non-AP MLD, a link reconfiguration notify frame that includes an indication of early termination of the downlink draining period; and
delete the links that were setup between the non-AP MLD and the first AP MLD based on the indication of early termination of the downlink draining period.
